(19) United States
(12) Patent Application Publication
(10) Pub. No.: US 2023/0315759 A1
(43) Pub. Date: Oct. 5, 2023

(54) A METHOD OF OPERATING A STORAGE DEVICE OF AN ACCESS POINT, A METHOD OF LOCATING A DEVICE CONTEXT OF AN END NODE DEVICE STORED IN A STORAGE DEVICE OF AN ACCESS POINT, AND AN ACCESS POINT

(71) Applicant: METHODS2BUSINESS B.V., Eindhoven (NL)

(72) Inventors: Milenko Maricic, Eindhoven (NL); Dejan Dumic, Eindhoven (NL); Marleen Boonen, Eindhoven (NL)

(21) Appl. No.: 18/024,919

(22) PCT Filed: Sep. 6, 2021
(86) PCT No.: PCT/NL2021/050539

§ 371 Date: Mar. 6, 2023

(30) Foreign Application Priority Data
Sep. 4, 2020 (NL) 2026408

(51) Int. Cl. G06F 16/28

(52) U.S. Cl. CPC G06F 16/282; H04W 88/08

(57) ABSTRACT

A method of operating a storage device of an access point providing network access to a number of end node devices is disclosed. Each end node device has a device identifier and a device context, the storage device has a context array stored in a contiguous part thereof, the context array comprises a plurality of context elements, each context element has a context index and configured for storing a device identifier and a device context of an end node device. The method comprises the steps of: creating, in the storage device of the access point, a hierarchical data structure comprising a plurality levels of nodes, each node comprises at least one data element, each data element is configured for at least storing a context index of a context element and linked to a device identifier of an end node device, and operating the hierarchical data structure together with context elements to associate device identifiers linked to data elements of the hierarchical data structure with respective device contexts of end node devices stored in the context elements.

### TECHNICAL FIELD

The present disclosure generally relates to the field of wireless networks, and, more specifically, to a method of operating a storage device of an access point, a method of locating a device context of an end node device stored in a storage device of an access point, and an access point.

### BACKGROUND

A network device having routing or switching functions often needs to perform an exact-match search, inquiry or lookup in a database using a search key, so as to locate a data entry related to the key associated with a terminal or an end node device in a network comprising the routing or switching network device. The data entry to be located may be for example a destination address of a packet, and the search key may be a source address identifying a terminal or end node device transmitting the packet.

In the case of a network operating according to a wireless Local Area Network, WLAN, standard, an access point, AP, operates to provide network access to a plurality of end node devices, also referred to as stations or clients. Each station, after being authenticated, will have its configuration and state saved in a storage device, such as a system memory, of the AP. A data structure having the configuration and state of the station accessing the AP saved therein is referred to as a station context, or simply a context.

According to some wireless network standards, such as IEEE 802.11ah standard branded under name Wi-Fi HaLow, an AP can provide network access to up to 8191 stations, therefore up to 8191 contexts have to be saved in the storage device of the AP.

Depending on the context of a specific station, the AP often needs to respond to a station transmitting a packet right after a short inter-frame space, SIFS, interval, which is for example 160 μs for the Wi-Fi HaLow 802.11ah standard. As an example, the AP has to generate an acknowledge, ACK, within the SIFS interval, in response to receiving the packet from the station.

Therefore, the AP has to find an appropriate context corresponding to the transmitting station, within a time shorter than the SIFS interval. The transmitting station may be identified either by a unique Media Access Control, MAC, address with a size of six bytes included in a received frame, or by an AID of two bytes assigned by the AP.

It is seen from the above that the memory required for storing the contexts and the quick search needed for retrieving an appropriate context from the storage device of the AP are two restrictions to be considered for the AP providing network access to the stations.

In terms of storage requirement, storing or saving contexts for a great number of stations may impose a heavy burden on the system memory of the AP, especially for many recently developed APs operating according to the Internet of Things, IoT, standards. This is due to such devices usually have limited system memory.

An alternative approach stores the contexts in an external memory, such as Random Access Memory, RAM, for example. However, accessing external memory or on chip RAM memory is slow and may create additional constraint on the efficiency of the search process.

Therefore, there is a genuine need for a method of efficiently managing storage spaces such that contexts of a large number of stations can be stored in the relatively small internal memory of the AP and a method of searching a required context in the internal memory of the AP in a fast way.

### SUMMARY

In a first aspect of the present disclosure, a method of operating a storage device of an access point, AP, is presented, the access point providing network access to a number of end node devices, each end node device having a device identifier and a device context, the storage device having a context array stored in a contiguous part thereof, the context array comprising a plurality of context elements, each context element having a context index and configured for storing a device identifier and a device context of an end node device, the method comprising the steps of:
creating, in the storage device of the access point, a hierarchical data structure comprising a plurality levels of nodes, each node comprising at least one data element, each data element configured for at least storing a context index of a context element and being linked to a device identifier of an end node device, and
operating the hierarchical data structure together with context elements to associate device identifiers linked to data elements of the hierarchical data structure with respective device contexts of end node devices stored in the context elements.

The present disclosure is based on the insight that a novel storage solution may allow efficient usage of a storage device of an AP and facilitate fast search of a device context of an end node device stored in the storage device of the AP. The storage solution uses a simple data array, i.e., a context array, in a larger contiguous storage area or space of the storage device of the AP, for storing device contexts of end node devices accessing the AP.

The storage solution further relies on the storage of a hierarchical data structure, which makes use of nodes arranged in multiple levels and comprising data elements occupying smaller storage areas, not necessarily contiguous. Each data element belonging or linked to a node of the hierarchical data structure stores a context index of a context element having a device context of an end node device stored therein. The data element is further linked to a device identifier of the end node device.

The device identifier of the end node device, which is normally used as a search key for locating the context element storing the device context of the end node device, is thus associated with the corresponding device context by way of the data element of the hierarchical data structure. Search or location of the context element containing the device context via the device identifier is therefore made possible.

The hierarchical data structure and the context array function together to associate device identifiers linked to data elements of the hierarchical data structure with respective device contexts of end node devices stored in the context elements.

Linking between the data element and the device identifier of the end node device may be simply realised by storing the device identifier, or a converted version of the device identifier such as a hashed device identifier, in the data element itself. The data element therefore stores a (context index, device identifier) pair, which allows efficient location of the context element containing the context of the end node device having the device identifier, by way of finding the data element having the context index that pairs up with the device identifier.

On the other hand, when storage space is indeed limited, the data element stores only the context index and is linked to the device identifier via the context index stored in the data element. This is due to that the context index points to the corresponding context element, which also stores the device identifier. This approach allows better efficiency in terms of storage usage.

In an embodiment of the present disclosure, a root node of the hierarchical data structure comprises a hash table, a size of the hash table determined according to a maximum number of end node devices, a hash table element with an index that is equal to a hashed device identifier stores a location of a subtree containing a data element linked with the device identifier.

Additionally, having a hash table as a top level or root node of the hierarchical data structure allows insertion and search operations of data elements to be performed in a fast way.

For example, a “chain” is represented as only one node. It can be contemplated by those skilled in the art that the chain may also be a tree structure of depth more than 1, more specifically a self-balanced tree, more specifically a self-balanced tree where nodes contain ordered array of data elements.

A hash function distributing elements of the hash table as uniformly as possible to “slots” of the hash table may be chosen such that collisions between device identifier hashed to a same index is kept to minimum. The hash table stores a location of a root node of the hierarchical data structure containing data elements that “collided”, i.e. data elements associated with device identifiers that hash to a same value.

In an embodiment of the present disclosure, subtree of each child node of the root node is a self-balanced tree.

It can be contemplated by those skilled in the art that the hierarchical data structure may be implemented using a number of known data structures. Different data structures have advantages and disadvantages in terms of memory usage and searching time, and may be chosen based on different application scenarios.

In a specific embodiment of the present disclosure, there may be more than one type of the data structure used for the subtree of child node. The exact type of data structure is determined based on the number of data elements stored in a subtree of that node. To make the later data element search possible the type of the data structure used is stored in a child node.

One specific example is to organizing subtree of each child node of the root node as a self-balanced tree. There are various implementations of self-balanced trees. In organizing the data elements linking the device identifiers of the end node devices with the context elements storing the contexts of the end node devices, a self-balanced tree has nodes comprising a set of data elements together with several pointers. Data elements in a single node may be ordered based on a device identifier or a compressed device identifier. In ordered node pointers to a child node are placed such that data elements of a child node maintain that ordering i.e., every data element device identifier of child node is greater than device identifiers found before the pointer to a child in a node and lower than device identifier found after the pointer to a child in the node.

In an embodiment of the present disclosure, descendant data elements of the root node are all children to the root node.

In such an implementation, the hierarchical data structure has a depth of two levels, thus implementation of specific self-balanced tree data structure and additional traversal, deletion and addition algorithms is avoided. This keeps the search of a data element, via a device identifier, for locating a context element comprising a context of an end node device having the device identifier simple and fast.

In a further embodiment of the present disclosure, data elements in every node are ordered by values of device identifiers or converted device identifiers linked to the data elements.

This further facilitates the fast search of the data element linked to the device identifier which is the search key, allowing the interested context element to be located within a shorter period of time.

In an embodiment of the present disclosure, the step of creating comprises the steps of:
deriving an index from a device identifier of an end node device newly connected to the access point, the index pointing to a subtree of the hierarchical data structure comprising a number of data elements of lower levels;
adding a data element to the subtree of the hierarchical data structure and storing a context index of an available context element of the context array in the added data element, and
storing a device context and the device identifier of the newly connected end node device in the available context element.

In real applications, the context array is allocated in the storage device of the AP and device contexts are filled into or removed from context elements of the context array when the end node devices connect to or disconnect from the AP.

When an end node device accesses the AP for the first time, the end node device is authenticated by the AP for verification that it is a supported end node device which may be connected to the AP. After the authentication, a new data element is created for associating a context index of an available context element in the context array with the device identifier of the end node device. This data element is added to the current hierarchical data structure.

In the case where a hash table is used as a root node of hierarchical data structure, the new data element is added to a node of a subtree that represents the collision resolution of the hash table and the subtree is linked to hash table. If there are no collisions on that hash index, new node is created and linked to hash table. The purpose of the hashing is to reduce the depth of the hierarchical data structure, thus reducing the time required to find the context given the device identifier.

Additionally, the device context of the end node device including its configuration and status is stored in the corresponding context element of the context array. It can be contemplated by those skilled in the art that the hierarchical data structure is also updated so as to maintain its integrity.

These steps are straightforward and easy to implement, which also facilitates searching for the added device context at a later stage.

In addition, where an end node device is disconnected from the AP, the method of the present disclosure first finds a data element linked to a device identifier of the newly disconnected device in the hierarchical data structure. Thereafter the data element is deleted from the hierarchical data structure, and storage space of the context element of the context array storing the context of the end node device is released.

Similar to the above embodiment of adding data element to the hierarchical data structure and storing the device context to the context element, here the data element of a disconnected end node device is deleted from the hierarchical data structure and the corresponding context element in the context array is freed. This allows limited storage space to be reused, allowing the AP to connect new end node devices, and a maximum number of allowed connections remains constant, which effectively increases the usage efficiency of the storage device.

In an embodiment of the present disclosure, the step of operating comprises:
storing a device identifier or a converted device identifier linked to a data element in the data element; or
associating a data element with a device identifier stored in a context element, the data element storing a same context index as the context element.

As discussed above, the device identifier of the end node is associated with the context element storing the corresponding context of the end node device by using the data element. This is implemented in one way by storing the device identifier, or a converted or compressed device identifier, of the end node device in the data element storing the context index of the context element. This allows high efficiency in terms of search of the context of the end node device. When the converted or compressed device identifier is stored in the data element, if further helps to save storage space in the storage device of the AP.

On the other hand, to further reduce the storage required for the data elements, each data element can store only the context index of the context element storing the end node device. The association is realised by using the device identifier stored in the context element. Such an approach is suitable for applications with much limited storage space in the AP but less strict requirement in terms search time.

In an embodiment of the present disclosure, the method further comprises a step of:
creating, in the storage device, an indicator array comprising a plurality of indicator elements, each indicator element being configured for storing context occupancy information associated with a respective context element.

As an example of efficient storage usage, the present disclosure may make use of a bit array, such as a bitmap, to indicate whether a certain context element of the context array is taken, that is, having a device context saved therein, or not. The bit array is the most compressed occupancy indicator for all contexts, therefore it can be read in a short time. It is used for quickly finding new unoccupied context element. This is very simple to implement and takes minimal storage place.

In a specific embodiment of the present disclosure where a node of the hierarchical data structure is implemented as a self-balanced tree, a node of the self-balanced tree is stored in the storage device of the access point as a block array, the block array is divided into blocks of a plurality of levels, each block of a level comprising a number of contiguous block part(s), a number of block parts in a block of a higher level being a multiple of a number of block parts in a block of a lower level, a total number of occupied block parts in blocks of all level being equal to the number of end node devices.

In the application scenario of an AP, the hierarchical data structure is dynamically changed through the AP's lifetime, whenever an end node device authenticates or de-authenticates itself. Therefore, it is stored in a memory block with dynamic management. Here a block part is a storage space reserved for data element, and blocks are a storage space for a node of the hierarchical data structure.

For implementations with only constant sized nodes, self-balanced trees with fixed sized nodes and simple memory pool comprised of blocks of fixed size is enough. For implementations where nodes are represented as contiguous array of variable size, a more complex memory management pool is required where there is an option to choose variable memory block for allocation or one from several sizes of blocks, designed in such a manner to optimize the memory usage of the data structure.

Memory pool specifically implemented as the block array functions as a dynamic memory storage for the hierarchical data structure of the present disclosure. The multi-level structure of the block array may be used to have blocks of varied size configured for efficient memory usage having in mind probabilities of certain number of hash collisions, i.e. certain size of a node. Different blocks of the block array can be defined in different memory space having varied size, which also provides much flexibility in terms of memory usage.

In an embodiment of the present disclosure, the method further comprises creating a block set in the storage device, the block set being configured for indicating usage status of blocks of a level, the method further comprising a step of allocating a block of requested level indicated as being free by the block set, in response to a request for a block of the requested level.

The block set is used to manage storage spaces in the storage device in a more efficient manner. Blocks of each level have a block set for indicating which blocks are free.

When an application issues a request for a memory block, it first determines the size of the smallest block that will satisfy the request and examines the corresponding block set. If the block set contains a free block, the block is marked as used and the allocation process is complete.

In another embodiment of the present disclosure, the method further comprises creating a block set in the storage device, the block set being configured for indicating usage status of blocks of a level, the method further comprising a step of splitting a block of a higher level into blocks of requested level and allocating a block of requested level or a step of merging a plurality of blocks of a lower level as a block of requested level and allocating a block of requested level, in response to a request for block of the requested level and the block set indicating no free block of the requested level exists.

In practice, the splitting step comprises steps of iteratively splitting a block of a higher level into blocks of lower level until requested size is bigger or equal compared to size of block on that level and allocating a block of lowest level with size bigger or equal than requested size, in response to a request for block of the requested size.

On the other hand, if a method of having the requested block size available is by a step of deallocating a block of given level, the deallocation may cause merging a plurality of “buddy” blocks of that level in a block of higher level and updating the block set accordingly.

When it is indicated by the block set there is no free block, the memory pool attempts to create one automatically by splitting a free block of a larger size or by merging free blocks of smaller sizes. The merging of blocks happens not upon allocation, but upon deallocation immediately, recursively and automatically.

In an embodiment of the present disclosure, a number of blocks of a highest level and a size of a block on every level and a size of the hash table are determined according to a maximum number of end node devices, time limitations of locating a device context and memory footprint.

An example of memory pool with several block sizes is a hierarchical tree memory pool known as buddy memory allocation, where every block is divided in two or more sub-blocks and a size of the block determines its level in the hierarchy.

Additional occupancy bitmap for every level is used together with linked list of free blocks on every level to allow for complete memory management. Sizes of blocks on every level and number of blocks on highest level are determined before compile time according to a maximum number of network devices accessing the access point and size of the hash array. If used properly it allows for compaction of memory with little overhead. Its performance in allocation and deallocation is important only in authentication and de-authentication of network device (not time-critical methods).

The number of blocks of the highest level represents a worst-case scenario, where capacity of a block of the highest level is not fully used. Detailed calculation shows that the block array even under the worst-case scenario uses relatively small amount of storage space, which shows that the block array is especially advantageous for APs with limited system memory.

In a second aspect of the present disclosure, there is presented a method of locating a device context of an end node device stored in a storage device of an access point, the access point providing network access to a number of end node devices, each end node device having a device identifier and a device context, the storage device having a context array stored in a contiguous part thereof, the context array comprising a plurality of context elements, each context element having a context index and configured for storing a device identifier and a device context of an end node device, the method comprising the steps of:
identifying, by using a device identifier or a converted device identifier of the end node device, a node in a hierarchical data structure stored in the storage device, the hierarchical data structure comprising a plurality levels of nodes, each node comprising at least one data element, each data element configured for at least storing a context index of a context element and being linked to a device identifier of an end node device;
traversing data element(s) of a subtree belonging to the identified node to determine a data element comprising a context index of a context element comprising the device identifier of the end node device, and
locating the device context stored in the context element comprising the device identifier of the end node device.

Based on the data structure as disclosed in the first aspect of the present disclosure, this method of locating a device context of an end node device makes use of a device identifier of the end node device to identify a node having a data element linking the device identifier to a context element storing the context of the end node device.

Specifically, the device identifier or a converted device identifier such as its hashed version is used to identify a node in a hierarchical data structure. The identified node may contain data element comprising the device identifier of the node device, or it may point to node on lower level that may contain above-mentioned data element. Therefore, the method then traverses the optionally ordered hierarchical data structure by comparing the device identifier of node device with device identifier(s) stored in the data element(s) of the identified node. The traversal consists of tree traversal, node traversal and comparison of device identifiers or compressed device identifiers.

The identified data element may be connected to data elements of lower levels. The method then traverses all necessary data elements of lower levels to locate the data element linked to the device identifier of the end node device. This data element comprises the context index of the context element storing the device context to be located.

The method locates the device context in a simple and easy-to-implement way. The method enjoys fast searching as a result of the data structure used. The method of traversing the data structure that is the child of the root node depends on the type of the structure. This method is described in more details for different embodiments in the detailed description.

In an embodiment of the present disclosure, the converted device identifier of the end node device is generated from the device identifier using a hash function unrelated to hash function of root node and specifically designed not to index to a hash table, but to make the hash collisions almost impossible, thus uniquely representing the device identifier with the compressed device identifier.

In an embodiment of the present disclosure, the step of traversing comprises comparing the device identifier of the end node device with device identifiers linked to the data elements, the device identifiers linked to the data elements being one of device identifiers stored in the data elements, converted device identifiers stored in the data elements, and externally available devices identifier.

As described above, the device identifier or its converted version may be stored also in the data element. In this case, comparing the device identifier and those stored in the data element provides a most efficient way of traversing the data elements connected to the identified data element.

On the other hand, the device identifier may be obtained from the context element pointed by the context index stored in the data element. Externally as used herein refers to being external to the data element.

In an embodiment of the present disclosure, wherein the device identifier of the end node device is a Medium Access Control, MAC address of the end node device.

A MAC address uniquely identifies the end node device and is always available to be used. Therefore, it is easily used a key for searching.

In a third aspect of the present disclosure, there is presented an access device providing network access to a number of end node devices, each end node device having a device identifier and a device context, the access device comprising:
a storage device arranged for storing a context array in a contiguous part thereof, the context array comprising a plurality of context elements, each context element having a context index and configured for storing a device identifier and a device context of an end node device;
the storage device further arranged for storing a hierarchical data structure comprising a plurality levels of nodes, each node comprising at least one data element, each data element configured for at least storing a context index of a context element and being linked to a device identifier of an end node device;
wherein the hierarchical data structure and the context elements are configured to operate together to associate device identifiers linked to data elements of the hierarchical data structure with respective device contexts of end node devices stored in the context elements.

The access point operates the hierarchical data structure and the context elements as defined in the first aspect of the present disclosure. It is especially advantageous for an access point with limited memory, as the hierarchical data structure helps to use the storage space more efficiently and avoid to waste memory space.

In an embodiment of the present disclosure, the access point further comprises:
an identification device arranged for identifying a node in the hierarchical data structure by using a device identifier or a converted device identifier of an end node device;
a traversing device arranged for traversing data element(s) of a subtree belonging to the identified node to determine a data element comprising a context index of a context element comprising the device identifier of the end node device, and
a locating device arranged for locating a device context stored in the context element comprising the device identifier of the end node device.

Each of the identification device, traversing device and locating device may be functional modules of a processor or processing unit of the access point, which together performs the steps for searching a device context of an end node device.

In an embodiment of the present disclosure, the storage device further arranged for storing an indicator array comprising a plurality of indicator elements, each indicator element being configured for storing context occupancy information associated with a respective context element.

In a fourth aspect of the present disclosure, a computer program product is provided, comprising a computer readable storage medium storing instructions which, when executed on at least one processor, cause the at least one processor to carry out the method according to the first aspect of the present disclosure.

In a fifth aspect of the present disclosure, a computer program product is provided, comprising a computer readable storage medium storing instructions which, when executed on at least one processor, cause the at least one processor to carry out the method according to the second aspect of the present disclosure

The above mentioned and other features and advantages of the disclosure will be best understood from the following description referring to the attached drawings. In the drawings, like reference numerals denote identical parts or parts performing an identical or comparable function or operation.

### BRIEF DESCRIPTION OF THE DRAWINGS

FIG. 1 illustrates, in a schematic diagram, a network comprising an access point, AP, operating in accordance with the present disclosure.

FIG. 2 illustrates a schematic diagram of a hierarchical data structure according to the present disclosure.

FIGS. 3a-3c illustrates, in a schematic diagram, data elements designed and operating in accordance with the present disclosure.

FIG. 4 illustrates, in a flow chart type of diagram, exemplary steps of a method for storing new contexts to a context array and adding new data element to the hierarchical data structure, in accordance with the present disclosure.

FIG. 5 illustrates, in a flow chart type diagram, exemplary steps of a method of removing data element for a node device newly disconnected from the access point, in accordance with an embodiment of the present disclosure.

FIG. 6 illustrates, in a schematic diagram, a general view of data structures designed and operating in accordance with the present disclosure.

FIG. 7 schematically illustrates a buddy allocator as used in the present disclosure.

FIG. 8 schematically illustrates, in a flow chart type diagram, exemplary steps of a method of locating a context in accordance with an embodiment of the present disclosure.

FIG. 9 schematically illustrates, in a block diagram, an AP in accordance with the present disclosure.

### DETAILED DESCRIPTION

Embodiments contemplated by the present disclosure will now be described in more detail with reference to the accompanying drawings. The disclosed subject matter should not be construed as limited to only the embodiments set forth herein. Rather, the illustrated embodiments are provided by way of example to convey the scope of the subject matter to those skilled in the art.

In the following description, the terms “end node device”, “node device”, “station”, “client” or “terminal device” are used interchangeably.

Although described with reference to Access Points and end node devices, the present disclosure is applicable to other network configurations.

In response to a packet received from a node device, an access point, AP, needs to search, using an identifier such as a Media Access Control, MAC, address or an AID of a node device as a key, a context stored in a storage device of the AP and related to the node device within a defined response time limit.

The present disclosure proposes a data structure that makes efficient use of the storage device of the AP and facilitates fast search of a required context of a node device saved in the storage device of the AP.

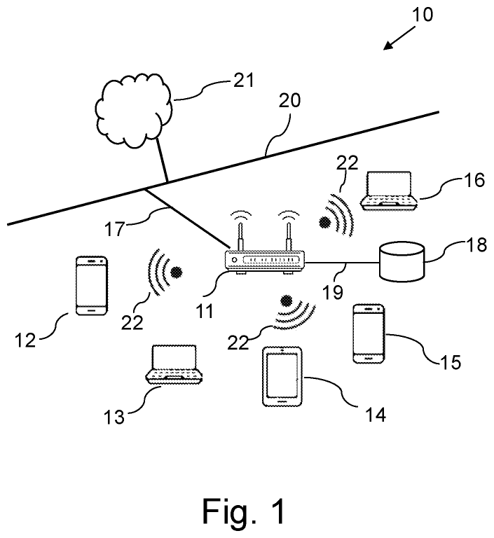

FIG. 1 illustrates, in a schematic diagram, a network 10 comprising an access point, AP 11, operating in accordance with the present disclosure. The AP 11 is connected, using wired connection 17, to a Local Area Network, LAN 20, for example, and thereby accessing the Ethernet 21.

The AP 11 provides network access, over wireless connections 22, to a plurality of node devices 12, 13, 14, 15, 16 comprised in the network 10. The AP 11 comprises and interacts with and controls a storage or repository device 18, via an internal data communication and control bus 19.

The storage device 18 of the AP 11 is configured for storing, among others, contexts of node devices connected to the AP 11. A number of contexts can be up to the number of connectable node devices supported by the AP 11.

Device contexts of end node devices 12-16 accessing the AP 11 may be stored in the storage device 18 of the AP 11 as a context array. The context array occupies a contiguous part of the storage device 18 and comprises a plurality of context elements (not shown), each context element has a context index and comprises a device context and a device identifier of an end node device accessing the AP 11.

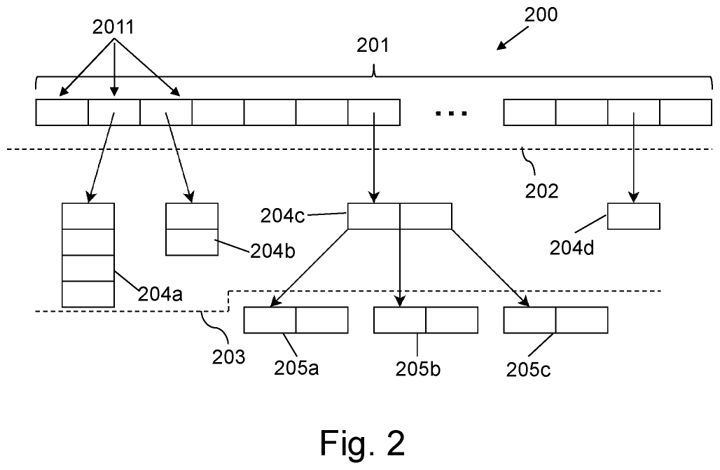

FIG. 2 illustrates, in a schematic diagram, a hierarchical data structure 200 that may be used in the present disclosure for facilitating quick search of contexts by using device identifiers. The hierarchical data structure 200 may comprise a plurality levels of nodes, each node comprising at least one data element, each data element functions to associate a device identifier linked to that data element with a respective device context of an end node device stored in a context element.

The data structure 200 may comprise a root node 201 as indicated on the topmost level above a line 202. The root node 201 may be for example a hash table, comprising a plurality of data element 2011, each of which being a hash table element.

A non-zero value in an element of the hash table points to a set of data elements stored in subtree of the hierarchical data structure. As seen from below description, a data element that represents an association between a specific device identifier such as a MAC address of the node device and a context corresponding to the node device with that MAC address can be found in the subtree.

In the case that the hash table is arranged as the root node of the hierarchical data structure, every node except for the root node may be only a contiguous array of data elements. This allows the hierarchical data structure to have a depth of two, which will make the searching for a data element for locating a context of a node device faster.

A lower level of the data structure 200 as illustrated in FIG. 2 comprises four nodes 204a-204d above the dashed bended line 203, with each node comprising one or more data elements. Each data element is configured for at least storing a context index of a context element. It can be contemplated that the lower level can comprise any number of nodes as necessary.

The node 204c is linked to a further lower level of nodes 205a-205c, each of which comprising two data elements.

The hierarchical data structure may store the type of the structure used as a subtree of children of the root node and the size of every node. This configuration enables it to be adapted to comprise various data structures and their combinations.

The hierarchical data structure may be arranged to comprise self-balanced trees as children of the root node. Each self-balanced tree represents the hash collision resolution. A node of a self-balanced tree is a contiguous array and may additionally point to other nodes.

Descendant data elements of the non-root node may also be ordered, for example based on device identifiers or converted device identifiers stored in the data elements. This will further facilitate fast searching of a needed data element.

Each data element of the hierarchical data structure, other than the hash table elements, is further linked to a device identifier of a node device, a context of the node device is stored in a context element of the context array, and a context index of the context element is stored in the data element. As a result, the device identifier of the node device is associated with the corresponding context of the same node device stored in the storage device of the AP by way of the data element.

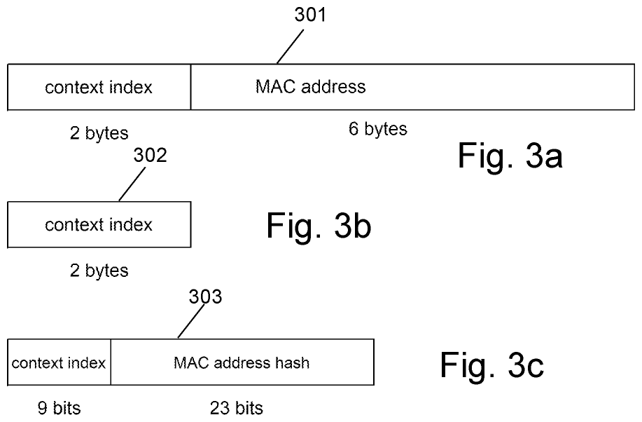

Several ways may be used to link a data element to a device identifier of a node device. FIGS. 3a-3c schematically illustrates examples of data elements and linking of data elements to the device identifiers.

All three data elements 301-303 stores a context index of a context element which stores a device identifier and a device context of a node device, the context index takes up 2-bytes storage.

In a specific implementation, part of the space of the context index of the first data element in the node is used to store the number of data elements in that node. In an example, a size of the node is at most equal to 32 data elements (64 bytes), five bits are reserved for this purpose.

The data element 301 further stores a device identifier such as a MAC address of the node device whose context is stored in the context element pointed by the context index stored in the data element 301. The MAC address requires six-bytes storage. Having the context index and MAC address stored in the same data elements thereby directly associates the device identifier to the context element storing the context of the node device identified by the device identifier. This solution requires two load operations per data element read on a 32-bit microcontroller.

When the device identifier is used to search for the context of the node device, the MAC address that is used for searching is compared with the MAC address in the data element, thereby finding data element having the context index of the context element storing the context of the node device, thereby locating the context that is needed.

With the data element 302, its linking to the device identifier is realised by using the device identifier in context element. Specifically, the context index in the data element is read to obtain the MAC address from the context element pointed by that context index. Then the searched MAC address is compared with the MAC address from the context element. This solution has three load operations from memory per data element, but has lower memory footprint, because no redundant MAC address in the data element is needed. Therefore, the data element 302 is advantageous with limited storage space.

The data element 303 consists of context index and a converted device identifier, such as a hash of the MAC address. To find the exact data element pointing to the context of the end node identified by the MAC address, the hash of searched MAC address and hash stored in the data element 303 is compared. A hash function may be selected to have good hashing qualities and fast. This solution has only one load operation in memory per data element.

The data element 303 is stored using four bytes instead of two bytes used for the data element 302 or eight bytes for the data element 301.

Additionally, an indicator array may also be created in the storage device of the AP. The indicator array comprises a plurality of indicator elements, each indicator element configured for storing context occupancy information associated with a respective context element. Good choice for indicator array both for memory consumption and fast load times is simple bitmap where one bit of memory represents one indicator element.

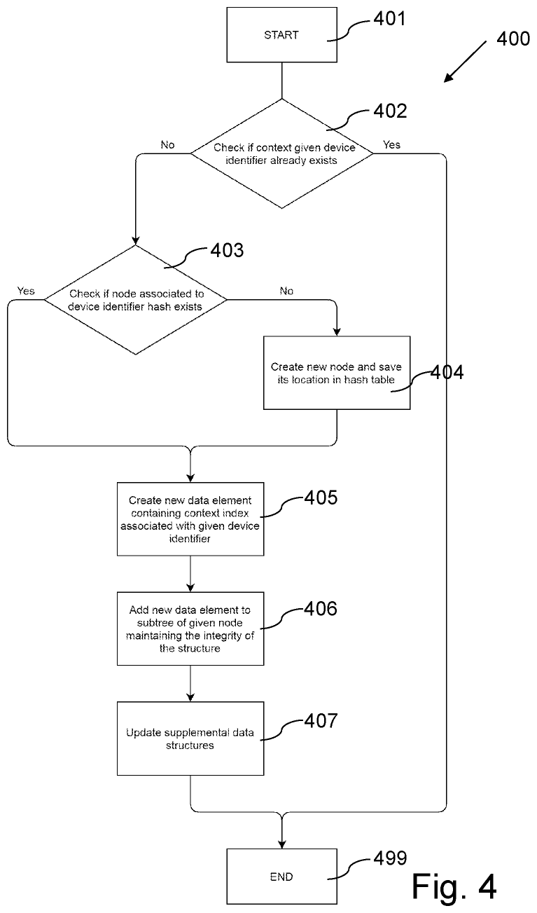

FIG. 4 illustrates, in a flow chart type of diagram, exemplary steps of a method 400 for storing new contexts to the context array and adding new data element to the hierarchical data structure, in accordance with the present disclosure.

When the method 400 starts 401 and a node device connects to and gets authenticated by the AP, it checks at step 402 whether a context related to a given device identifier identifying the node device already exists. If the context is already available at the context array, new context for the same device identifier cannot be added, the method proceeds to step 499 and ends.

If it is determined at step 402 that the context of the node device is not available in the context array, the method 400 proceeds to step 403 and checks if a node associated to a hash of the device identifier exists. If such node does not exist, the method 400 proceeds to step 404 to create a new node and save its location in a hash table.

Specifically, the device identifier is hashed to generate an index of the hash table. If a value of a hash table element on that index is equal to 0, a new node needs to be created. This requires allocation of smallest block.

The method 400 then proceeds to step 405. If the node associated to the hash of the device identifier already exists, the method 400 proceeds to step 405 directly.

At step 405, the method 400 creates a new data element containing a context index associated with or linked to the given device identifier, the given device identifier may be stored in the data element as well.

Next, at step 406, the new data element is added to a subtree of the node. In buddy memory allocator implementation of memory pool, this corresponds to adding a new data element to the block occupied by the node data. If the block has no empty space for the new data element, a new block of higher level is allocated, data from the old block is copied to the new block and old block is deallocated before adding new data element.

In a specific implementation where the data elements in the nodes are ordered based on value of device identifiers or compressed device identifiers, the new data element is inserted to maintain the order of the data elements.

In addition, the device context of the node device identified by the given device identifier is saved to the context element pointed by the context index. The added data element therefore associates the given device identifier of the node device newly connected to the AP to the context of the node device which is stored in the context array.

The method 400 may further comprise a step 407 of updating supplemental data structures such as an indicator for indicating context occupancy associated with the respective context element storing the context.

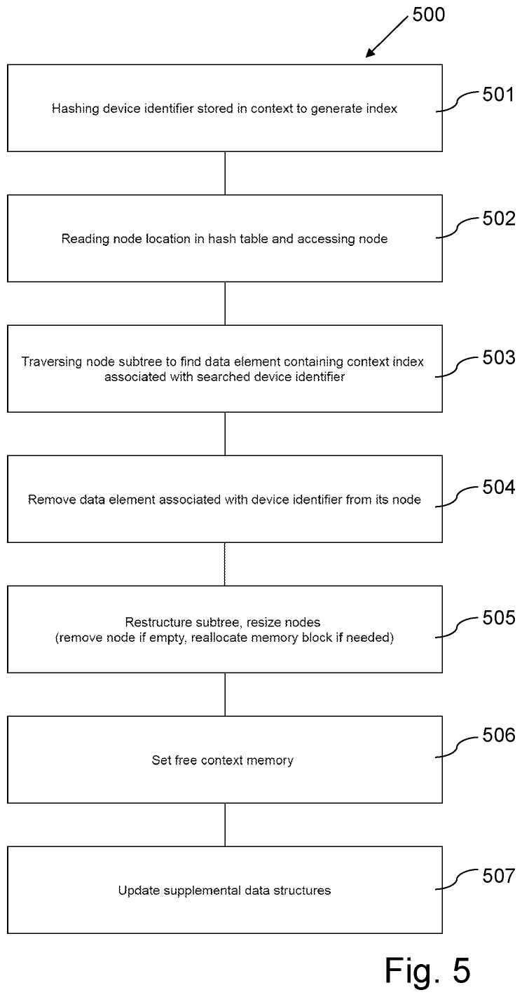

FIG. 5 illustrates, in a flow chart type diagram, exemplary steps of a method 500 of removing data element linked to a node device newly disconnected from the access point, in accordance with an embodiment of the present disclosure.

First, at step 501, the device identifier of the node device stored in the context element is hashed to generate an index. At step 502, the generated index is used to read a node location in the hash table, and if node location has non-zero value, an associated node of the hierarchical data structure is accessed. At step 503, a subtree of the node is traversed to find a data element containing the context index associated with or linked to the searched device identifier. If data element associated with searched device identifier is not found the deletion ends unsuccessfully. Steps 501, 502 and 503 are analogue to search method steps 801, 802 and 803 explained later in document. At step 504, the data element associated with the device identifier is removed from the node.

The method 500 may optionally further comprise steps 505 to 507. At step 505, the subtree is reconstructed, and the nodes are resized. Specifically, if the node is now empty, this node is removed. If the node can fit in smaller memory block, new smaller memory block is allocated, node is copied into this new block and old memory block is deallocated. A memory block occupied by the node may be reallocated if needed. At step 506, context element reserved for said device identifier is set as unoccupied and may be initialized to all zeros. At step 507, the occupancy indicator may be set free, indicating that the context element is now free and other supplemental data structures are updated accordingly.

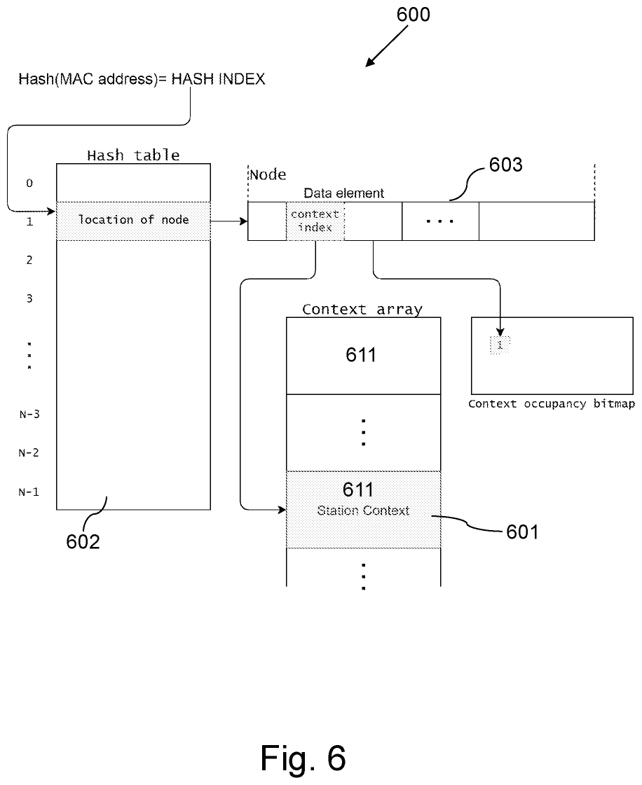

FIG. 6 illustrates, in a schematic diagram, a general view 600 of data structures designed and operating in accordance with the present disclosure. In this example, a root node of the hierarchical data structure is a hash table, and data elements comprised by the lower level nodes are stored in the storage device of the AP as a part of a memory pool.

A context array 601 comprises a plurality of context elements 611 and takes up a contiguous space in the storage device or memory of the AP which is required for storing device contexts and device identifiers of all node devices supported for accessing an AP. Each context element 611 is identified by context index and stores device information such as device identifier.

A hash table 602 together with a contiguous array comprising a plurality of block parts, with one exemplary block part 603 illustrated in FIG. 6, form the hierarchical data structure in accordance with the present disclosure.

The hash table 602 is the root node or the topmost level of the hierarchical data structure. It may be considered as an extra level of a regular hierarchical data structure. The hash table stores a location of a root node of the hierarchical data structure containing data elements that “collided”, i.e. data elements associated to device identifiers that hash to a same value.

Hash collision is resolved with separate chaining, hash table points to a location of “chain” structure. In this example, “chain” is represented as only one node. It can be contemplated by those skilled in the art that the chain may also be a tree structure of depth more than 1, more specifically self-balanced tree, more specifically a self-balanced tree where nodes contain ordered array of data elements.

In a specific example, the AP supports a maximum number of 512 node devices, and a hash function is used to convert a device identifier of each node device to an index of a hash table. In this example, storage space for contiguous array of the hierarchical data structure is implemented as a memory pool with buddy memory allocation. Memory pool is divided in array of blocks of highest level. Every block is further divided in whole number of blocks in the next lower level. All blocks may contain data elements and padding if block is not filled.

That is, the block array comprises blocks of a plurality of levels, each block of a level comprising a number of contiguous block part(s), a number of block parts in a block of a higher level being a multiple of a number of block parts in a block of a lower level.

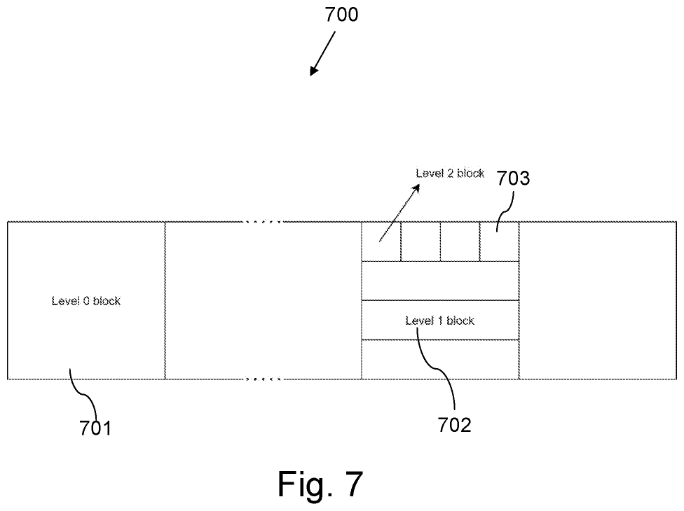

FIG. 7 schematically illustrates a buddy allocator 700 as used in the present disclosure. In FIG. 7 a level 0 block 701, a level 1 block 702 and a number of level 2 blocks 703 are illustrated.

In accordance with the present disclosure, a number of blocks of a highest level and size of a block on every level as well as the size of the hash table are determined according to a maximum number of end node devices accessing the access point, time limitations of locating a device context and memory footprint.

Choosing the size of the hash table and the configuration of the memory pool results in a specific memory and search time footprint. The exact choice depends on the specific implementation. There are various configurations to choose from and the whole data structure is designed to be robust and modular.

For a given size of block on every level, the number of blocks on the highest level is determined based on a worst-case scenario where block padding is the greatest. One implementation uses 302 type of data element as illustrated in FIG. 3b, only one level of nodes beside the hash table root node, buddy memory allocator where every level has blocks four times bigger then lower level (can be represented as forest of quad trees) and ordered array of data elements in every node. It has three levels of blocks in a memory pool such as 700, level 2 blocks 703 with size 4 bytes (fits at most 2 data elements), level 1 blocks 702 with size of 16 bytes (fits at most 8 data elements) and level 0 blocks 701 with size of 64 bytes (fits at most 32 data elements). In a worst-case scenario 9 elements are fitted in a 32-element block which for 512 stations results in 57 or less blocks needed in the highest level. This is rounded to 60 blocks. Size of the hash table is chosen to be the smallest possible value not to increase search time over 3 us on a 96 MHz processor. This results in 60*64B+128*16B=5.75 KB of memory.

Another implementation uses 301 type of data element as illustrated in FIG. 3a, only one level of nodes beside the hash table root node, buddy memory allocator where every level has blocks four times bigger then lower level (can be represented as forest of quad trees) and unordered array of data elements in every node. It has three levels of blocks in a memory pool such as 700, level 2 blocks 703 with size 8 bytes (fits at most 1 data element), level 1 blocks 702 with size of 32 bytes (fits at most 4 data elements) and level 0 blocks 701 with size of 128 bytes (fits at most 16 data elements). In a worst-case scenario 5 elements are fitted in a 16-element block which for 512 stations results in 103 or less blocks needed in the highest level. This is rounded to 100 blocks since worst-case scenario is highly unlikely. Size of the hash table is 512. This results in 100*128B+512*16B=20.5 KB of memory.

Additionally, the memory pool keeps track of how its buffer space has been partitioned using an array of block set data structures. There is one block set for each partitioning level supported by the pool, or for each block size. A block set keeps track of all free blocks of its associated size using linked list of free blocks on every level and bitmap with allocation status for every block.

The above describes the general data structure as used by the present disclosure. In the following, operation of the storage device having the data structure of the present disclosure stored therein will be described.

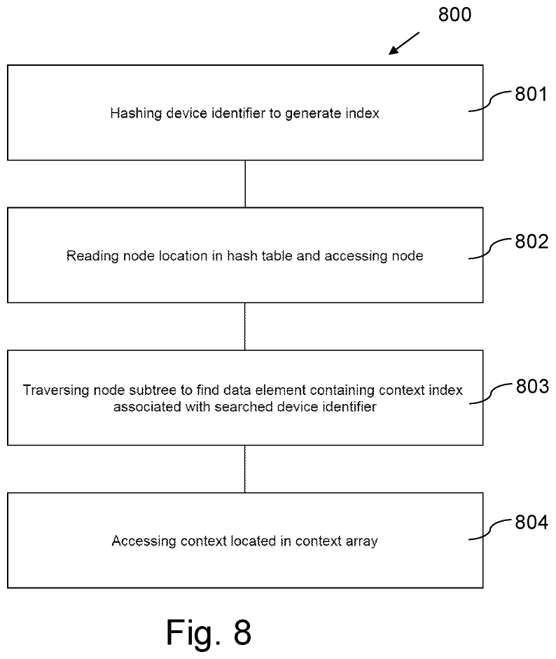

FIG. 8 schematically illustrates in a flow chart type diagram, exemplary steps of a method 800 of locating a context of a node device by using a device identifier of the node device, in accordance with an embodiment of the present disclosure.

At step 801, a processing device or processor of the AP applies a conversion function to a device identifier of an end node device to generate an index. The conversion function may be hash function, such as a multiplication hash function, which is simple to implement, fast, and is well suited for the present disclosure.

Since first three bytes of MAC address are organizationally unique identifier, OUI, hence stations from same assignee often have the same 3 most significant bytes and since processor performing the hash is 32-bit processor, hashing function with 4 least significant bytes of MAC address as input may be used. This 4-byte input choice provides better heterogeneity of hash input and therefore less collisions.

At step 802, the processor reads a node location in the hash table element indexed by the generated index. If the node location has a non-zero value the node is accessed.

The node comprises one or more data elements in the hierarchical data structure, each data element storing a device identifier which hashes to the index generated at step 801.

At step 803, the processor traverses a subtree of the node to find a data element containing a context index associated with the device identifier which is used as the search key.

For a known data structure the traversal, adding and deletion is known to those skilled in the art.

The traversal algorithm consists of a combination of tree traversal and a node traversal and data element traversal. It depends on the specific implementation i.e. type of the subtree structure, the structure of the node itself and type of the data element used.

It can be contemplated by those skilled in the art that specific self-balanced trees have well-defined traversal algorithms. One such structure is 2-3 B-tree with node comprised of at most 2 ordered data elements and 3 pointers to child nodes. The blocks for storing nodes of 2-3 B-tree are of constant size thus eliminating the need for a memory pool. The downsides of this variation of implementation are additional complexity of search, addition and deletion algorithms and additional complexity of the verification of firmware.

In a specific implementation with linked list nodes are traversed sequentially.

In a specific implementation where nodes pointed from hash table have no descendants the complexity of the self-balanced tree is avoided. Here, the tree traversal algorithm is non-existent.

Nodes implemented as unordered array of data elements are traversed linearly. Nodes implemented as ordered array may be traversed using binary search.

In a specific implementation using type 301 of data elements, traversing of one element comprise loading data element of 8 bytes (2 words) from memory and two 32 bit comparison of MAC addresses. In another specific implementation using type 302 of data elements, traversing of one element comprise loading data element of 2 bytes or 2 data elements at once (1 word) from memory, loading MAC address stored in read context element (2 loads from memory) and two 32 bit comparison of MAC addresses. First matching MAC address ends the traverse successfully.

If the end of the subtree is reached and no match is found search halts unsuccessfully.

Then at step 804, a device context in a context element pointed by the context index is located. This successfully completes the locating or search operation.

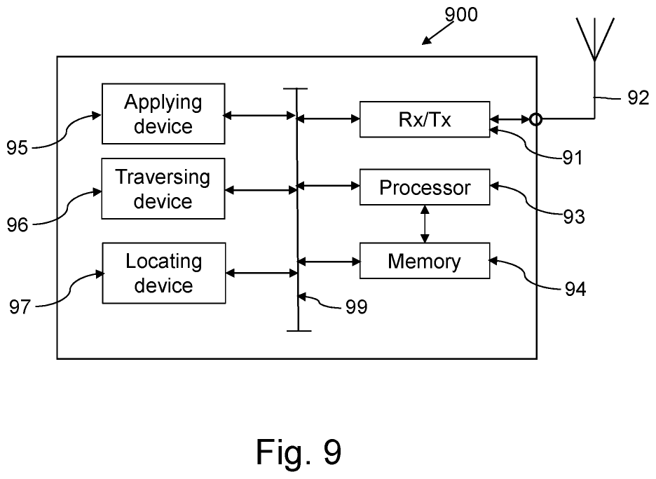

FIG. 9 schematically illustrates a network access device 900 such as an AP operating its storage device and locating a context stored therein in accordance with the present disclosure.

The network access device 900 operates a communication interface 91, such as a network adapter or transceiver, Tx/Rx, module arranged for wireless 92 and optionally wired exchange of messages or data packets with other end node device. Network protocols for exchanging data ZigBee™, Bluetooth™, as well as Wi-Fi based protocols for wireless networks.

The network access device 900 further comprises at least one microprocessor, μP, or controller 93, and at least one data repository or storage or memory 94, among others for storing for example device contexts of end node devices connected to the network access device 900, as well as information related to the end node devices, such as identifiers, IDs, Media Access Control, MAC, addresses of the end node devices. Instead of the data repository 94, a separate memory or storage accessible to the at least one processor or controller 93 may be provided.

The storage or memory 94 is further arranged for storing the data structure, including the hierarchical data structure, the indicator bit array and the block set as disclosed by the present disclosure.

The network access device 900 further comprises an identifying device 95, a traversing device 96 and a locating device 97, all of which communicatively connected to the at least one processor or controller 93 by way of an internal communication bus 99.

The identifying device 95 is arranged for applying a conversion function to a device identifier of an end node device to generate an index identifying a node location in the hierarchical data structure stored in the storage device 94.

The traversing device 96 is arranged for traversing data elements of subtree belonging to the node identified by the generated index to determine a data element comprising the context index associated with the device identifier of the end node device.

The locating device 97 is arranged for locating a device context stored in a context element of the context array, the context element being pointed by the context index.

The present disclosure is not limited to the examples as disclosed above, and can be modified and enhanced by those skilled in the art beyond the scope of the present disclosure as disclosed in the appended claims without having to apply inventive skills and for use in any data communication, data exchange and data processing environment, system or network.

1-19. (canceled)

20. A method of operating a storage device of an access point, the access point providing network access to a number of end node devices, each end node device having a device identifier and a device context, the storage device having a context array stored in a contiguous part thereof, the context array comprising a plurality of context elements, each context element having a context index and configured for storing a device identifier and a device context of an end node device, the method comprising the steps of:
creating, in the storage device of the access point, a hierarchical data structure comprising a plurality of levels of nodes, each node comprising at least one data element, each data element configured for at least storing a context index of a context element and being linked to a device identifier of an end node device; and
operating the hierarchical data structure together with context elements to associate device identifiers linked to data elements of the hierarchical data structure with respective device contexts of end node devices stored in the context elements;
wherein a root node of the hierarchical data structure comprises a hash table, a hash table element with an index that is equal to a hashed device identifier stores a location of a subtree containing at least one data element linked with the device identifier, and
wherein the different children node subtrees of the root node comprise different data structures selected from a set of predetermined data structures including at least one of an ordered block array, an unordered block array, a self-balanced tree, and a linked list, a type of data structure of a children node determined based on a number of data elements stored in a subtree of that node.

21. The method according to claim 20, wherein the different children node subtrees of the root node comprise data structures being a linked list.

22. The method according to claim 21, wherein the subtree of each child node of the root node is a self-balanced tree.

23. The method according to claim 22, wherein descendant nodes of the root node are all children to the root node.

24. The method according to claim 22, wherein every node is comprised of an array of data elements ordered by values of device identifiers or converted device identifiers linked to the data elements.

25. The method according to claim 20, wherein the step of creating comprises the steps of:
deriving an index from a device identifier of an end node device newly connected to the access point, the index pointing to a subtree of the hierarchical data structure comprising a number of data elements of lower levels;
adding a data element to the subtree of the hierarchical data structure and storing a context index of an available context element of the context array in the added data element; and
storing a device context and the device identifier of the newly connected end node device in the available context element.

26. The method according to claim 20, wherein the step of operating comprises an adding operation being:
storing a device identifier or a converted device identifier linked to a data element in the data element; or
associating a data element with a device identifier stored in a context element, the data element storing a same context index as the context element.

27. The method according to claim 20, further comprising a step of:
creating, in the storage device, an indicator array comprising a plurality of indicator elements, each indicator element being used as a flag for context occupancy information associated with a respective context element.

28. The method according to claim 20, wherein the different children node subtrees of the root node are stored using buddy memory allocation.

29. The method according to claim 28, wherein a number of blocks of a highest level and a size of a block on every level and a size of the hash table are determined based on a maximum number of end node devices, time limitations of locating a device context, and memory footprint.

30. The method according to claim 20, implemented as a computer program product, comprising a computer readable storage medium storing instructions which, when executed on at least one processor, cause the at least one processor to carry out the method.

31. A method of locating a device context of an end node device stored in a storage device of an access point, the access point providing network access to a number of end node devices, each end node device having a device identifier and a device context, the storage device having a context array stored in a contiguous part thereof, the context array comprising a plurality of context elements, each context element having a context index and configured for storing a device identifier and a device context of an end node device, the method comprising the steps of:
identifying, by using a device identifier or a converted device identifier of the end node device, a node in a hierarchical data structure stored in the storage device, the hierarchical data structure comprising a plurality of levels of nodes, each node comprising at least one data element, each data element configured for at least storing a context index of a context element and being linked to a device identifier of an end node device;
traversing at least one data element of a subtree belonging to the identified node to determine a data element comprising a context index of a context element comprising the device identifier of the end node device; and
locating the device context stored in the context element comprising the device identifier of the end node device.

32. The method according to claim 31, wherein the converted device identifier of the end node device is generated from the device identifier using a hash function.

33. The method according to claim 31, wherein the step of traversing comprises comparing the device identifier of the end node device with device identifiers linked to the data elements, the device identifiers linked to the data elements being one of device identifiers stored in the data elements, converted device identifiers stored in the data elements, and externally available devices identifier.

34. The method according to claim 31, wherein the device identifier of the end node device is a Medium Access Control (MAC) address of the end node device.

35. The method according to claim 31, implemented as a computer program product, comprising a computer readable storage medium storing instructions which, when executed on at least one processor, cause the at least one processor to carry out the method.

36. An access device providing network access to a number of end node devices, each end node device having a device identifier and a device context, the access device comprising:
a storage device configured for storing a context array in a contiguous part thereof, the context array comprising a plurality of context elements, each context element having a context index and configured for storing a device identifier and a device context of an end node device;
the storage device further configured for storing a hierarchical data structure comprising a plurality of levels of nodes, each node comprising at least one data element, each data element configured for at least storing a context index of a context element and being linked to a device identifier of an end node device; and
wherein the hierarchical data structure and the context elements are configured to operate together to associate device identifiers linked to data elements of the hierarchical data structure with respective device contexts of end node devices stored in the context elements.

37. The access device according to claim 36, further comprising:
an identification device configured for identifying a node in the hierarchical data structure by using a device identifier or a converted device identifier of an end node device;
a traversing device configured for traversing at least one data element of a subtree belonging to the identified node to determine a data element comprising a context index of a context element comprising the device identifier of the end node device; and
a locating device configured for locating a device context stored in the context element comprising the device identifier of the end node device.

38. The access device according to claim 36, wherein the storage device is further configured for storing an indicator array comprising a plurality of indicator elements, each indicator element being configured for storing context occupancy information associated with a respective context element.
